(19) United States
(12) Patent Application Publication
(10) Pub. No.: US 2016/0204915 A1
(43) Pub. Date: Jul. 14, 2016

(54) APPARATUS, COMPUTER READABLE MEDIUM, AND METHOD FOR GENERATING AND RECEIVING SIGNAL FIELDS IN A HIGH EFFICIENCY WIRELESS LOCAL-AREA NETWORK

(71) Applicants: Xiaogang Chen, Beijing (CN); Qinghua Li, San Ramon, CA (US); Robert J. Stacey, Portland, OR (US); Yuan Zhu, Beijing (CN)

(72) Inventors: Xiaogang Chen, Beijing (CN); Qinghua Li, San Ramon, CA (US); Robert J. Stacey, Portland, OR (US); Yuan Zhu, Beijing (CN)

(21) Appl. No.: 14/743,807

(22) Filed: Jun. 18, 2015

Related U.S. Application Data
(60) Provisional application No. 62/103,142, filed on Jan. 14, 2015.

(51) Int. Cl. H04L 5/00; H04L 1/00; H04W 72/04

(52) U.S. Cl. CPC H04L 5/0037; H04W 72/042; H04L 5/0016; H04L 1/0061; H04W 84/12

(57) ABSTRACT

Apparatus, computer readable medium, and method for generating and receiving signal fields in a high efficiency wireless local-area network (WLAN) are disclosed. A master station is disclosed that may include circuitry configured to generate a high-efficiency signal field (HE-SIG) for a plurality of stations (STAs). The HE-SIG may include a HE-SIGA and a HE-SIGB. The HE-SIGB may include a plurality of resource allocations for the plurality of STAs. The resource allocations may be individually encoded or jointly encoded with a separate CRC for each resource allocation. The circuitry may be configured to transmit the HE-SIG to each of the plurality of STAs. A STA is disclosed that may include circuitry to receive a HE-SIG with a HE-SIGB that includes resource allocations for STAs with the resource allocations either being individually encoded or jointly encoded and with a separate CRC for each resource allocation.

### PRIORITY CLAIM

This application claims the benefit of priority under 35 USC 119(e) to U.S. Provisional Patent Application Ser. No. 62/103,142, filed Jan. 14, 2015, which is incorporated herein by reference in its entirety.

### TECHNICAL FIELD

Embodiments relate to Institute of Electrical and Electronic Engineers (IEEE) 802.11. Some embodiments relate to high-efficiency wireless local-area networks (HEWs). Some embodiments relate to IEEE 802.11ax. Some embodiments relate to orthogonal frequency division multi-access (OFDMA) and/or multiple-input multiple-output (MIMO) resource allocations transmitted to a plurality of stations by a master station using a signal field.

### BACKGROUND

Efficient use of the resources of a wireless local-area network (WLAN) is important to provide bandwidth and acceptable response times to the users of the WLAN. Many wireless devices may be contending for the use of the wireless medium. Moreover, wireless devices may be using different communication standards.

Thus, there are general needs for improved methods, apparatuses, and computer readable media for allocating resources to users of a WLAN.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a HE packet in accordance with some embodiments;

FIG. 3 illustrates an example of a HE-SIGB where STA signaling is individually encoded in accordance with some embodiments;

FIG. 4 illustrates an example of a HE-SIGB where the STA signaling is jointly encoded with a separate CRC for each STA in accordance with some embodiments;

FIG. 5 illustrates a graph of a performance comparison of different encoding methods;

FIG. 6 illustrates an example of a HE-SIGB with STA signaling that straddle multiple OFDM symbols and with STA signaling with different MCS levels in accordance with some embodiments;

FIG. 7 illustrates an example of a resource allocation in accordance with some embodiments;

FIGS. 8, 9, and 10 illustrate examples of resource allocations in accordance with some embodiments; and

FIG. 11 illustrates a HEW station in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

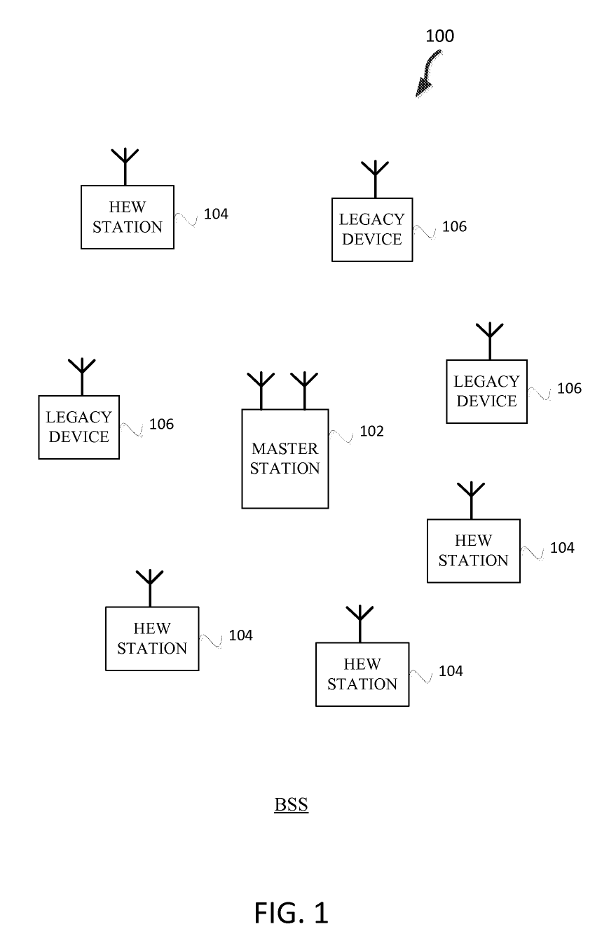

FIG. 1 illustrates a WLAN 100 in accordance with some embodiments. The WLAN 100 may comprise a basis service set (BSS) 100 that may include a master station 102, which may be an AP, a plurality of high-efficiency wireless (HEW) (e.g., IEEE 802.11ax) STAs 104 and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using OFDMA, time division multiple access (TDMA), and/or code division multiple access (CDMA). The IEEE 802.11 protocol may include a multiple access technique. For example, the IEEE 802.11 protocol may include space-division multiple access (SDMA) and/or MU-MIMO.

The legacy devices 106 may operate in accordance with one or more of IEEE 802.11 a/g/ag/n/ac, or another legacy wireless communication standard. The legacy devices 106 may be STAs or IEEE STAs.

The HEW STAs 104 may be wireless transmit and receive devices such as cellular telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The BSS 100 may operate on a primary channel and one or more secondary channels or sub-channels. The BSS 100 may include one or more master stations 102. In accordance with some embodiments, the master station 102 may communicate with one or more of the HEW devices 104 on one or more of the secondary channels or sub-channels or the primary channel. In accordance with some embodiments, the master station 102 communicates with the legacy devices 106 on the primary channel. In accordance with some embodiments, the master station 102 may be configured to communicate concurrently with one or more of the HEW STAs 104 on one or more of the secondary channels and a legacy device 106 utilizing only the primary channel and not utilizing any of the secondary channels.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques. Legacy IEEE 802.11 communication techniques may refer to any IEEE 802.11 communication technique prior to IEEE 802.11ax.

In some embodiments, a HEW frame may be configurable to have the same bandwidth as a sub-channel, and the bandwidth may be one of 20 MHz, 40 MHz, or 80 MHz, 160 MHz, 320 MHz contiguous bandwidths or an 80+80 MHz (160 MHz) non-contiguous bandwidth. In some embodiments, bandwidths of 1 MHz, 1.25 MHz, 2.0 MHz, 2.5 MHz, 5 MHz and 10 MHz, or a combination thereof or another bandwidth that is less or equal to the available bandwidth, may also be used. A HEW frame may be configured for transmitting a number of spatial streams, which may be in accordance with MU-MIMO.

In other embodiments, the master station 102, HEW STA 104, and/or legacy device 106 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.11ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger frame or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, the HEW STAs 104 may operate on a sub-channel smaller than the operating range of the master station 102. During the HEW control period, legacy stations refrain from communicating. In accordance with some embodiments, during the master-sync transmission the HEW STAs 104 may contend for the wireless medium with the legacy devices 106 being excluded from contending for the wireless medium during the master-sync transmission.

In some embodiments, the multiple-access technique used during the HEW control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

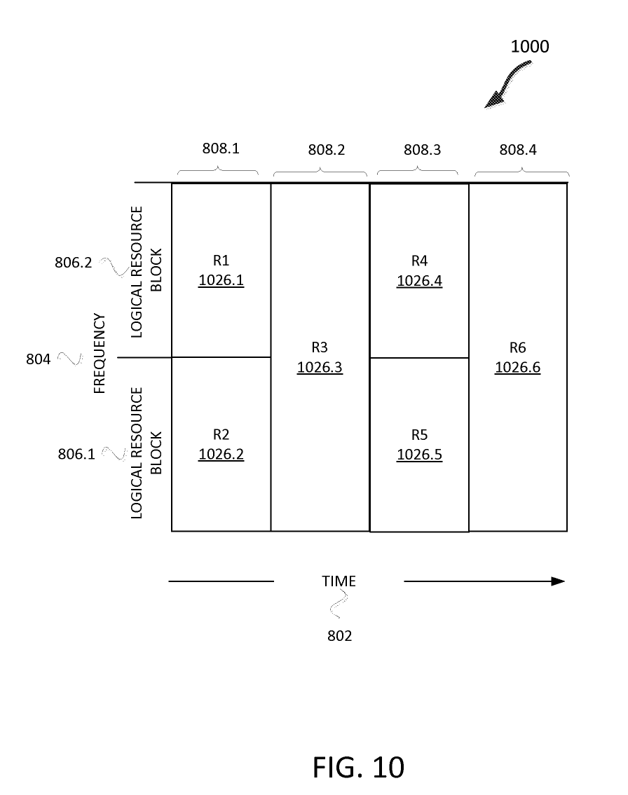

In example embodiments, the master station 102 and/or HEW stations 104 are configured to perform one or more of the functions and/or methods described herein in conjunction with FIGS. 1-11 such as generating HE-SIGs that include resource allocations, transmitting resource allocations to HEW stations 104, receiving HE-SIGs with resource allocations, and operating in accordance with the resource allocations.

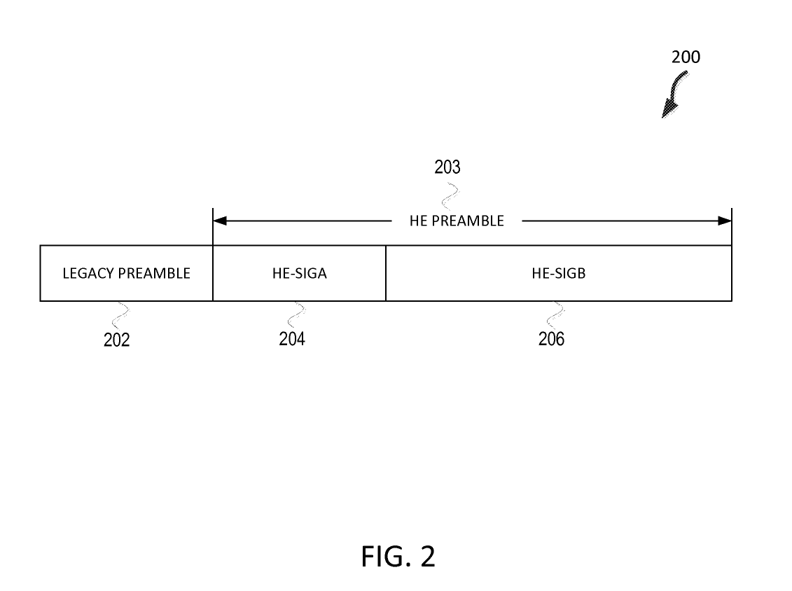

FIG. 2 illustrates a HE packet 200 in accordance with some embodiments. The HE packet 200 may include a legacy preamble 202 and a HE preamble 203. The legacy preamble 202 may be a preamble in accordance with a legacy standard. The legacy preamble 202 may be used by legacy stations 106 to determine that the HE packet 200 is not intended for a legacy station 106. The legacy preamble 202 may be used by HEW stations 104 to determine that the HE packet 200 is a HE packet 200.

The HE preamble 203 may include two parts a HE-SIGA 204 and a HEW-SIGB 206. HE-SIGA 202 may include common information shared by more than one of the scheduled HEW stations 104 referred to in HE-SIGB 206. HE-SIGB 206 includes HEW station 104 specific information for HEW stations 104.

HE-SIGA 204 may include information that may be used to decode HE-SIGB 206. For example, HE-SIGA 204 may include a modulation and coding scheme (MCS) of HEW-SIGB 206, repetition information, a symbol length of HEW-SIGB 206, and guard interval (GI) length of HEW-SIGB 206. The HEW-SIGB 206 includes a resource allocation used for data detection or data transmission by HEW stations 104. The structure of HEW-SIGB 206 may vary in how it indicates the resource allocation information. The resource allocation information may include a location of the resource allocation such as a sub-channel, a MCS, and a duration of the resource allocation.

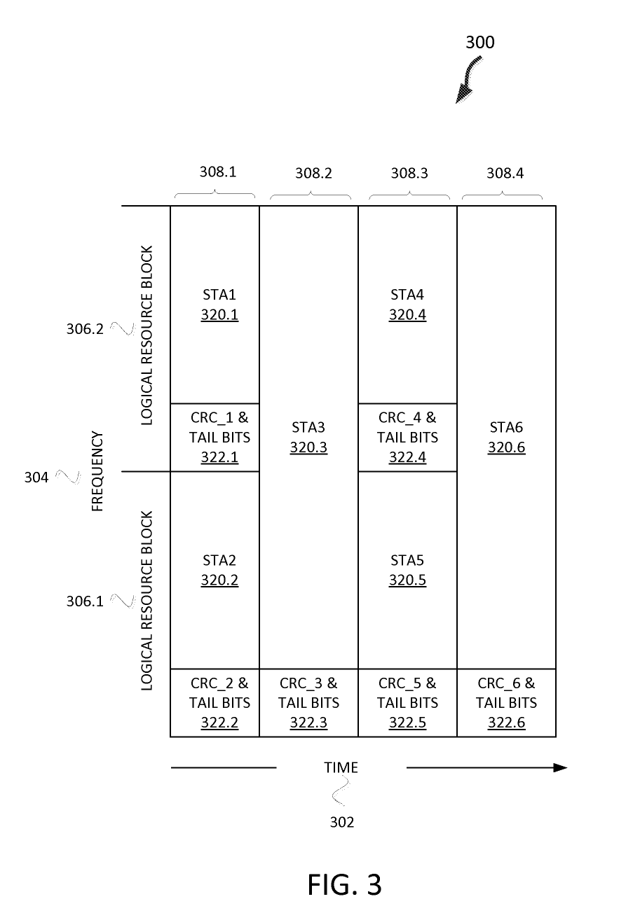

FIG. 3 illustrates an example of a HE-SIGB 300 where STA signaling 320 is individually encoded in accordance with some embodiments. Illustrated in FIG. 3 is time 302 along the horizontal axis, frequency 304 along the vertical axis, logical resource blocks 306.1, 306.2, symbol number 308, STA signaling 320, and cyclic redundancy check (CRC) and tail bits 322. The STAs may be a HEW stations 104. As illustrated the HE-SIGB 300 is four symbols 308 that carry the STA signaling 320 for six STAs. A different number of symbols 308 may be used and/or a different number of STA signals 320 may be carried for a different number of STAs.

As illustrated in FIG. 3, the STA signaling 320 for each STA can be individually encoded and each STA may have its own CRC check 322 masked by a station identification. The STA signaling 320 may be an indication of a resource allocation for the corresponding STA. For example, STA signaling 320.1 may be a resource allocation for STA1, which may be a HEW station 104. CRC_1 & tail bits 322.1 may be the CRC for the STA signaling 320.1, which may include tail bits for a convolution code. In example embodiments, the tail bits may not be included. In example embodiments, the CRC and/or tail bits 322 are masked with an address of the STA. The STA may be configured to determine whether the STA signaling 320 is for the STA by unmasking the CRC & tail bits 322 with the address of the STA and if the CRC is correct, then the STA assumes the STA signaling 320 is intended for the STA. The address of the HEW station 104 may be an association identification (AID), for example, or a partial association identification (PAID). In example embodiments, an address of the STA is included in the STA signaling 320.

In example embodiments, the HE-SIGB 300 may have four symbols 308.1, 308.2, 308.3, 308.4, that are used to transit the STA signaling 320 for six STA. The STA signaling 320 for each STA is individually encoded with CRC bits at the end of the encoded STA signaling 320. The logical resource blocks 306.1, 306.2 are a basic resource unit, which may include a number of distributed subcarriers, used to carry the encoded STA signaling 320 for one STA.

In example embodiments, symbols 308 may be coded and sequentially sent to an interleaver. The logical resource blocks 306.1, 306.2, may in this way be distributed. The interleaver interleaves the input coded symbols over the subcarriers of each orthogonal frequency division multiplexing (OFDM) symbol 308. In example embodiments, the interleaver loads the input coded symbols onto the subcarriers in an order different from the input order. In example embodiments, a legacy interleaver such as an interleaver used by IEEE 802.11a/n/ac may be used.

Repetition information may be specified in HEW-SIGA 204. For example, as illustrated in FIG. 3 the STA signaling 320 for STA3 and STA6 may each be repeated once. The STA may determine which portion of the symbols 308 is repeated after decoding HEW-SIGA 204. For a repeated portion of the coded symbols, the STA may combine the received, repeated STA signaling 320 of the same coded symbol after de-interleaving and before channel decoding.

The STA may be configured to check all of the CRCs by unmasking the CRC with its own station address. If one CRC check passed, then STA will assume the corresponding STA signaling 320 is for the STA.

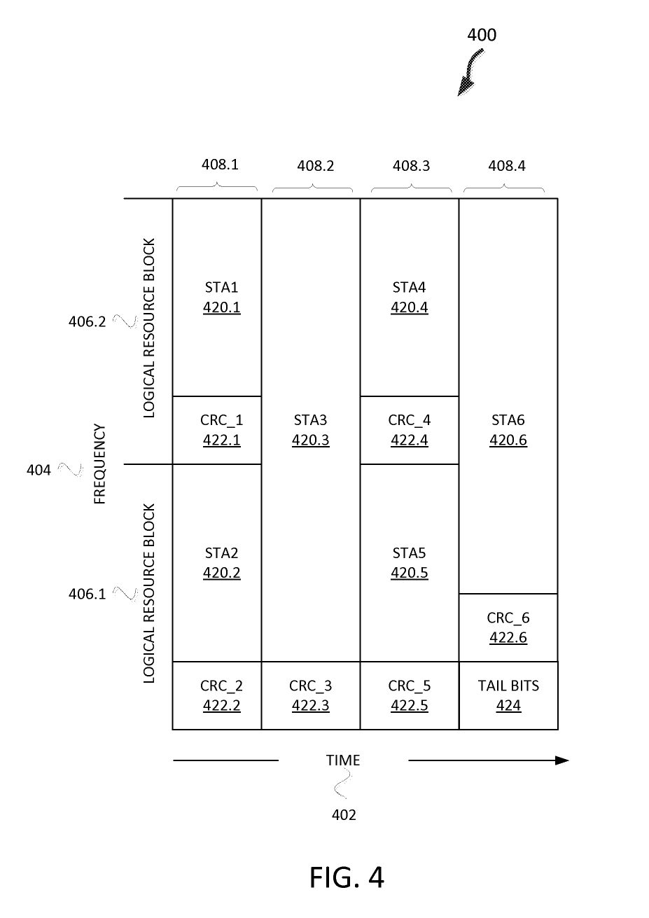

FIG. 4 illustrates an example of a HE-SIGB 400 where the STA signaling 420 is jointly encoded with a separate CRC for each STA in accordance with some embodiments. Illustrated in FIG. 4 is time 402 along the horizontal axis, frequency 404 along the vertical axis, logical resource blocks 406.1, 406.2, symbol number 408, STA signaling 420 for STAs, cyclic redundancy check (CRC) 422, and tail bits 424.

The STA signaling 420 for each STA may be jointly encoded and each STA may have its own CRC 422 masked by an address of the STA. The CRC 422 may be bits attached at the end of the un-encoded information bits for each STA. The tail bits 424 may be bits for the convolution encoder.

As illustrated the HE-SIGB 400 is four symbols 408 that carry the STA signaling 420 for six STAs. A different number of symbols 408 may be used and/or a different number of STA signals 420 may be carried for a different number of STAs.

In example embodiments, the symbols 408 may be jointly coded and sequentially sent to an interleaver. The logical resource blocks 406.1, 406.2, may in this way be distributed. The interleaver interleaves the input coded symbols over the subcarriers of each orthogonal frequency division multiplexing (OFDM) symbol 408. In example embodiments, the interleaver loads the input coded symbols onto the subcarriers in an order different from the input order. In example embodiments, a legacy interleaver such as an interleaver used by IEEE 802.11a/n/ac may be used.

The STA may be configured to check all of the CRCs by unmasking the CRC with its own station address. If one CRC check passed, then STA will determine the corresponding STA signaling is for the STA.

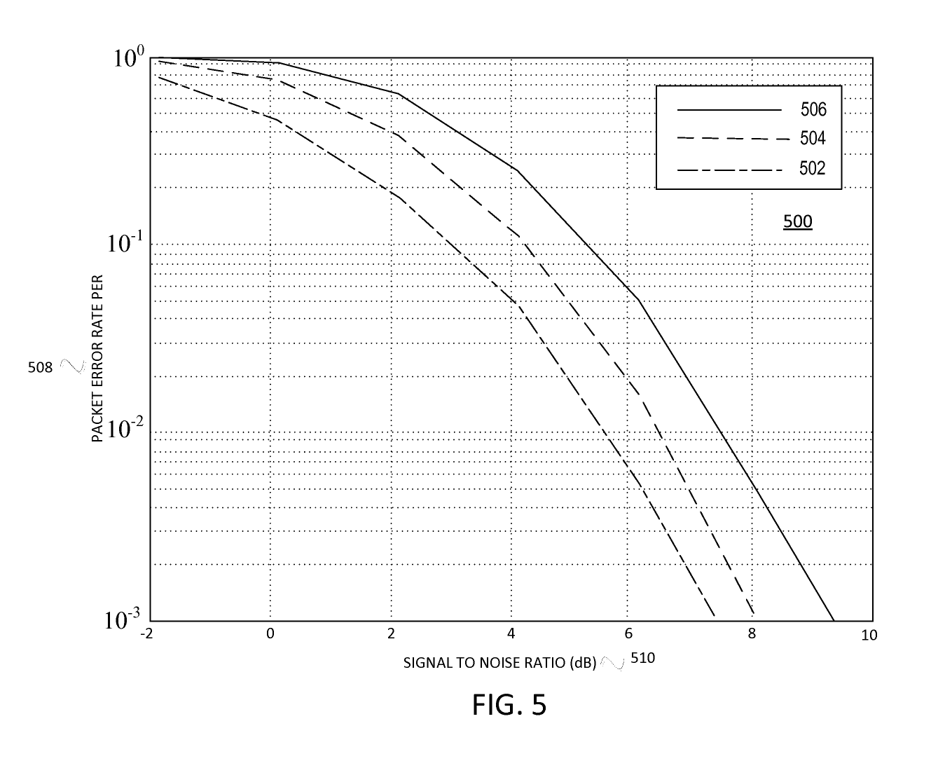

FIG. 5 illustrates a graph 500 of a performance comparison of different encoding methods. Illustrated in FIG. 5 is packet error rate per 508 along the vertical axis and signal to noise ratio in decibel (dB) 510 along the horizontal axis. Curve 502 represents the performance of STAs transmitting and receiving a HE-SIGB 300 (FIG. 3) where STA signaling 320 for each STA is individually encoded with a separate CRC for each STA signaling 320. Curve 504 represents the performance of STAs transmitting and receiving a HE-SIGB 400 (FIG. 4) where the STA signaling 420 is jointly encoded with a separate CRCs for each STA signaling 420. Curve 506 represents the performance of STAs transmitting and receiving a HE-SIGB where STA signaling for each station is jointly encoded and there is one CRC for all the STA signaling. Curve 502 has the fewest errors, with curve 504 having the second fewest errors, and curve 506 having the most errors.

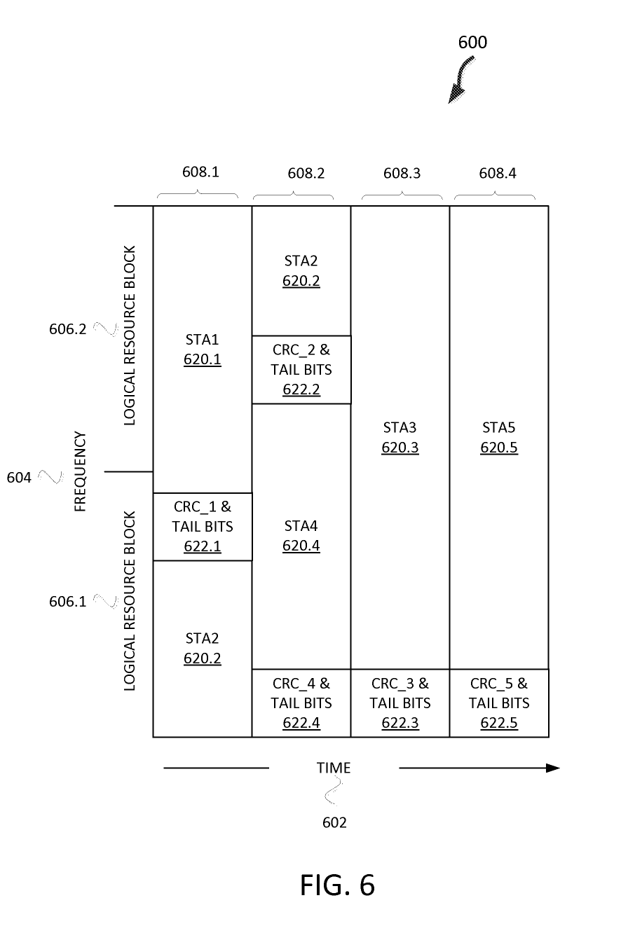

FIG. 6 illustrates an example of a HE-SIGB 600 with STA signaling 620 that straddle multiple OFDM symbols 608 and with STA signaling 620 with different MCS levels in accordance with some embodiments. Illustrated in FIG. 6 is time 602 along the horizontal axis, frequency 604 along the vertical axis, logical resource blocks 606.1, 606.2, symbol number 608, STA signaling 620 for STAs, cyclic redundancy check (CRC) and tail bits 622.

In example embodiments, the coded symbols for STA signaling 620 can straddle across multiple OFDM symbols. In example embodiments, the coded symbols for STA signaling 620 may not exactly fit into the payload of half symbol (logical resource block 606) or one OFDM symbol 608. The coded symbols of one STA may be loaded to multiple adjacent OFDM symbols 608. For example, the STA2 signaling 620.2 straddles OFDM symbol 608.1 and OFDM symbol 608.2. Moreover, the STA1 signaling 620.1 extends past the logical resource block 606.2 of one half of an OFDM symbol 608. In example embodiments, the payload size for each STA signaling 620 may be a constant. In example embodiments, the number of bits for a STA signaling 620 may vary, and in order to fix the payload size, padding bits may be used to fill up the leftover payload bits.

In example embodiments, different MCS level regions (MCS regions) can be used, which may simplify the implementation. STA signaling 620 with different MCS levels may be grouped together. For example, the OFDM symbols 608 of the HE-SIGB 600 may be portioned into groups. Each group may be for a different repetition level. For example, as illustrated in FIG. 6, OFDM symbols 608.1 and 608.2 have a repetition of one, while OFDM symbols 608.3 and 608.4 have a repetition of two. Grouping different MCS levels together may reduce the hardware complexity needed to decode the HE-SIGB 600.

In example embodiments, the coded symbols of each STA signaling 620 are not repeated and not sent to the same interleaver as before. Instead, the coded symbols of the STA signaling 620 are not repeated but they are sent to multiple different interleavers. The output of different interleavers are loaded to the subcarriers of different OFDM symbols 608 and get transmitted. In the group for N times repetition, N different interleavers may be used repeatedly for N adjacent OFDM symbols 608. For example, two interleavers (L1, L2) are used for 2× repetition group such as OFDM symbols 608.3 and 608.4. The interleavers may vary with the OFDM symbols 608. For example, for the first four OFDM symbols 608.1, 608.2, 608.3, and 608.4, four different interleavers L1, L2, L1, L2 may be used. In example embodiments, the interleavers may be simply generated from the same interleaver by a cyclic shift with different shift amounts.

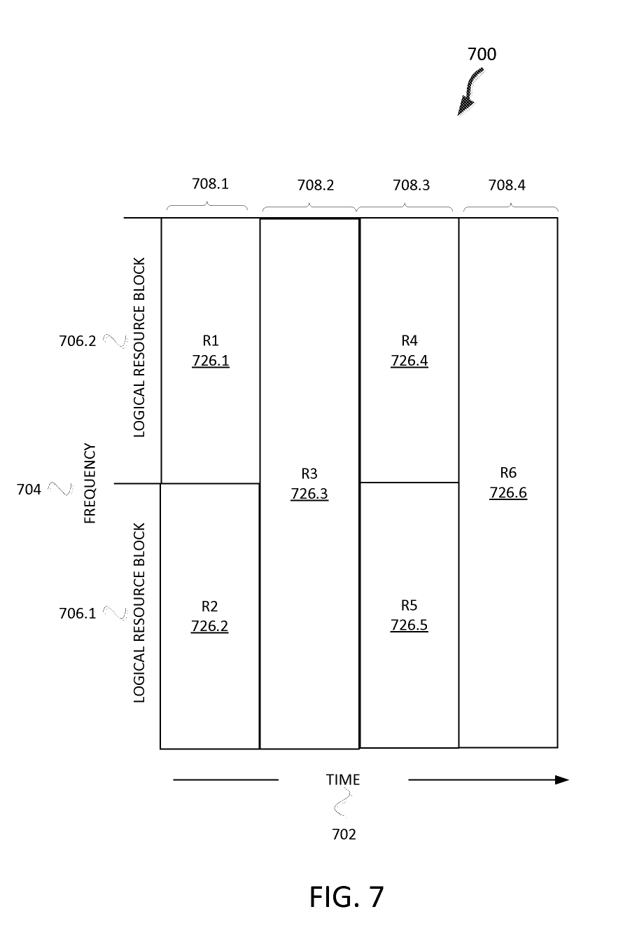

FIG. 7 illustrates an example of a resource allocation 700 in accordance with some embodiments. Illustrated in FIG. 6 is time 702 along the horizontal axis, frequency 704 along the vertical axis, logical resource blocks 706.1, 706.2, symbol number 708, and resources (R) 726 for STA signaling and CRC and tail bits.

The resources (R) 726 are portions of the HE-SIGB that are allocated for STA signaling to different stations. For example, resource allocation 700 corresponds to the HE-SIGB 400 (FIG. 4) with R1 726.1 allocation to STA1, R2 726.2 allocated to STA2, R3 726.3 allocated to STA3, R4 726.4 allocated to STA4, R5 726.5 allocated to STA5, and R6 726.6 allocated to STA6.

The resources R 726 may be explicitly indicated. The resources R 726 may indicate a MCS. For example, the HE-SIGA 204 (FIG. 2) may include a bitmap such as 001001. There may be two levels of MCS where a zero in the bitmap indicates no repetition of a STA signaling and a one in the bitmap indicates a single repetition of a STA signaling. Bitmap 001001 may indicate that STA1 signaling corresponds to R1 726.1, STA2 signaling corresponds to R2 726.2, etc. Moreover, the 1 at positions 3 and 6 of the bitmap 001001 may indicate that STA3 signaling and STA6 signaling is to be repeated once such as in FIG. 4.

In example embodiments, if more than 2 MCS levels are supported for HEW-SIGB transmission, a differential MCS can be used to save the signaling overhead. In example embodiments, a common MCS and a differential MCS is assigned to each STA by HE-SIGA 204. For example, the master station 102 can assign R1-R6 in FIG. 7 to STA1-STA6 (STA3 and STA6 have MCS1 and STA1/2/4/5 have MCS2), and can assign a common MCS2 and use differential MCS bit map 001001 to assign MCS1 for STA3/6 (3rd and 6th bit in the bit map stands for the differential MCS of STA3 and STA6).

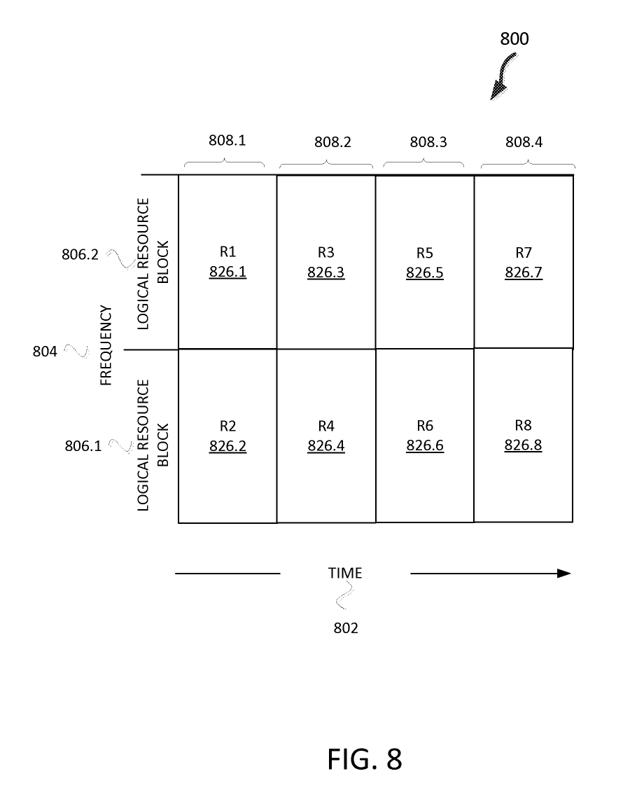

FIGS. 8, 9, and 10 illustrate examples of resource allocations 800, 900, 1000 in accordance with some embodiments. Illustrated in FIGS. 8, 9, and 10 are time 802 along the horizontal axis, frequency 804 along the vertical axis, logical resource blocks 806.1, 806.2, symbol number 808, and resources (R) 826, 926, 1026 for STA signaling and CRC and tail bits.

The resource allocation 800, 900, 1000 may be patterns that are known to both the HEW stations 104 and master station 102. The master station 102 may signal which resource allocation 800, 900, 1000 is going to be used. For example, the master station 102 may indicate which resource allocation 800, 900, 1000 is going to be used in a HE-SIGA 204 (FIG. 2).

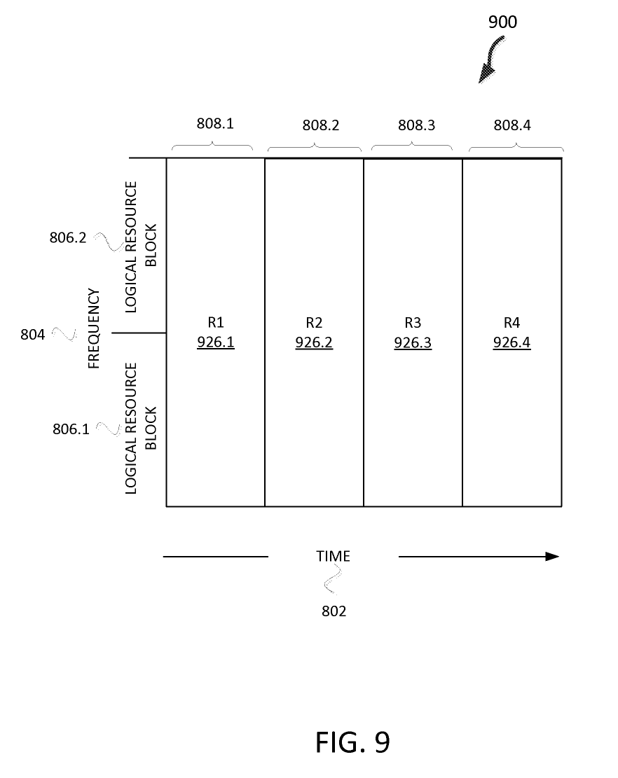

The resource allocations 800, 900, 1000 may indicate different levels of MCS for different stations. For example, R3 826.3 (FIG. 8) indicates no repetition of the STA signaling whereas R3 926.3 (FIG. 9) indicates one repetition. In this way, the MCS level may be determined by the resource allocation 800, 900, 1000 and the position of the STA signaling. In example embodiments, these patterns can be selected by a pattern selection bit or bits in HE-SIGA.

In example embodiments, if only two MCS levels are supported in HE-SIGB, two bits in a HE-SIGA may be used to indicate 4 patterns. For example, pattern 1 may be resource allocation 800 where all resource blocks 826 are MCS0, which may be no repetition; pattern 2: may be resource allocation 900 where all resource blocks 926 are MCS1, which may be one repetition; patterns 3 and 4: may be mixed MCSO and MCS1 such as resource allocation 1000 where some resource allocations 1026 indicate no repetition (e.g., R1 1026.1) and some resource allocations 1026 indicate one repetition (e.g. R3 1026.3). In example embodiments, more than two levels of MCS may be used. In example embodiments, a different number of patterns may be used such as 8, 16, 32, etc.

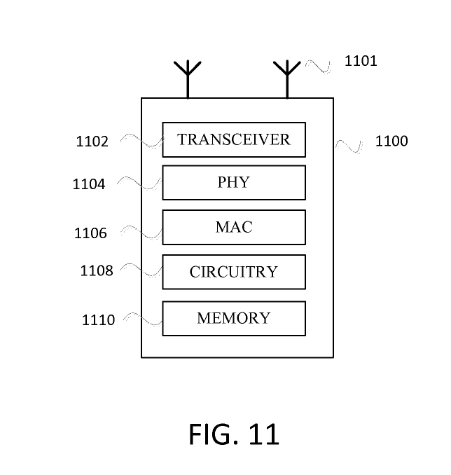

FIG. 11 illustrates a HEW device in accordance with some embodiments. HEW device 1100 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 1100 may be suitable for operating as master station 102 (FIG. 1) or a HEW STA 104 (FIG. 1). In accordance with embodiments, HEW device 1100 may include, among other things, a transmit/receive element 1101 (for example an antenna), a transceiver 1102, physical (PHY) circuitry 1104, and media access control (MAC) circuitry 1106. PHY circuitry 1104 and MAC circuitry 1106 may be HEW compliant layers and may also be compliant with one or more legacy IEEE 802.11 standards. MAC circuitry 1106 may be arranged to configure packets such as a physical layer convergence procedure (PLCP) protocol data unit (PPDUs) and arranged to transmit and receive PPDUs, among other things. HEW device 1100 may also include circuitry 1108 and memory 1110 configured to perform the various operations described herein. The circuitry 1108 may be coupled to the transceiver 1102, which may be coupled to the transmit/receive element 1101. While FIG. 11 depicts the circuitry 1108 and the transceiver 1102 as separate components, the circuitry 1108 and the transceiver 1102 may be integrated together in an electronic package or chip.

In some embodiments, the MAC circuitry 1106 may be arranged to contend for a wireless medium during a contention period to receive control of the medium for the HEW control period and configure an HEW PPDU. In some embodiments, the MAC circuitry 1106 may be arranged to contend for the wireless medium based on channel contention settings, a transmitting power level, and a CCA level.

The PHY circuitry 1104 may be arranged to transmit the HEW PPDU. The PHY circuitry 1104 may include circuitry for modulation/demodulation, upconversion/downconversion, filtering, amplification, etc. In some embodiments, the circuitry 1108 may include one or more processors. The circuitry 1108 may be configured to perform functions based on instructions being stored in a RAM or ROM, or based on special purpose circuitry. The circuitry 1108 may be termed processing circuitry in accordance with some embodiments. The circuitry 1108 may include a processor such as a general purpose processor or special purpose processor. The circuitry 1108 may implement one or more functions associated with transmit/receive elements 1101, the transceiver 1102, the PHY circuitry 1104, the MAC circuitry 1106, and/or the memory 1110.

In some embodiments, the circuitry 1108 may be configured to perform one or more of the functions and/or methods described herein and/or in conjunction with FIGS. 1-11 such as generating HE-SIGs that include resource allocations, transmitting resource allocations to HEW stations 104, receiving HE-SIGs with resource allocations, and operating in accordance with the resource allocations.

In some embodiments, the transmit/receive elements 1101 may be two or more antennas that may be coupled to the PHY circuitry 1104 and arranged for sending and receiving signals including transmission of the HEW packets. The transceiver 1102 may transmit and receive data such as HEW PPDU and packets that include an indication that the HEW device 1100 should adapt the channel contention settings according to settings included in the packet. The memory 1110 may store information for configuring the other circuitry to perform operations for configuring and transmitting HEW packets and performing the various operations to perform one or more of the functions and/or methods described herein and/or in conjunction with FIGS. 1-11 such as generating HE-SIGs that include resource allocations, transmitting resource allocations to HEW stations 104, receiving HE-SIGs with resource allocations, and operating in accordance with the resource allocations.

In some embodiments, the HEW device 1100 may be configured to communicate using OFDM communication signals over a multicarrier communication channel. In some embodiments, HEW device 1100 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 1100 may use 4× symbol duration of 802.11n or 802.11ac.

In some embodiments, an HEW device 1100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 1101 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 1100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is an apparatus of a master station. The apparatus includes circuitry configured to: generate a high-efficiency signal field (HE-SIG) for a plurality of stations (STAs), where the HE-SIG comprises a HE-SIGA and a HE-SIGB, and where the HE-SIGB includes a plurality of resource allocations for the plurality of STAs, and where the plurality of resource allocations are one from the following group: individually encoded or jointly encoded with a separate cyclic redundancy check (CRC) for each resource allocation; and transmit the HE-SIG to the plurality of STAs.

In Example 2, the subject matter of Example 1 can optionally include where resource allocations are for an uplink (UL) multi-user (MU) transmission opportunity (TXOP).

In Example 3, the subject matter of Example 1 or 2 can optionally include where the plurality of resource allocations that are individually encoded are not interleaved with one another.

In Example 4, the subject matter of any of Examples 1-3 can optionally include where each resource allocation includes a field for tail bits.

In Example 5, the subject matter of any of Examples 1-4 can optionally include where the HE-SIGB further comprises tail bits for the plurality of resource allocations.

In Example 6, the subject matter of any of Examples 1-5 can optionally include where the HE-SIGA includes one or more from the following group: a modulation and coding scheme (MCS) of the HE-SIGB, repetition information of the HE-SIGB, a symbol length of the HE-SIGB, and guard interval (GI) length of the HE-SIGB.

In Example 7, the subject matter of any of Examples 1-6 can optionally include where the HE-SIGB is encoded with multiple orthogonal frequency division multiple access (OFDMA) symbols.

In Example 8, the subject matter of any of Examples 1-7 can optionally include where the plurality of resource allocations are encoded using at least two different modulation and coding schemes.

In Example 9, the subject matter of Example 8 can optionally include where at least one resource allocation is repeated for at least one of the plurality of resource allocations.

In Example 10, the subject matter of any of Examples 1-9 can optionally include where the CRC is masked with an identification of the corresponding STA.

In Example 11, the subject matter of any of Examples 1-10 can optionally include where the HE-SIGA further comprises an indication of a pattern of modulation and coding schemes (MCSs) for the plurality of resource allocations.

In Example 12, the subject matter of Example 11 can optionally include where the pattern of MCS is an indication of which resource allocations are to be repeated twice.

In Example 13, the subject matter of any of Examples 1-12 can optionally include where the circuitry further comprises processing circuitry and transceiver circuitry.

In Example 14, the subject matter of any of Examples 1-13 can optionally include memory coupled to the circuitry; and, one or more antennas coupled to the circuitry.

Example 15 is a method on a master station. The method including generating a high-efficiency signal field (HE-SIG) for a plurality of stations (STAs), where the HE-SIG comprises a HE-SIGA and a HE-SIGB, and where the HE-SIGB includes a plurality of resource allocations for the plurality of STAs, and where the plurality of resource allocations are one from the following group: individually encoded or jointly encoded with a separate cyclic redundancy check (CRC) for each resource allocation; and transmitting the HE-SIG to the plurality of STAs.

In Example 16, the subject matter of Example 15 can optionally include where the HE-SIGB is to be encoded with orthogonal frequency division multiple access (OFDMA) symbols.

In Example 17, the subject matter of Examples 15 and 16 can optionally include where the at least one resource allocation straddles across multiple (OFDMA) symbols.

In Example 18, the subject matter of any of Examples 15-17 can optionally include where the plurality of resource allocations are encoded using at least two modulation and coding schemes.

In Example 19, the subject matter of Example 18 can optionally include where at least one resource allocation is repeated for at least one of the plurality of resource allocations.

Example 20 is an apparatus of a first station (STA). The apparatus including circuitry configured to: receive a high-efficiency signal field (HE-SIG), where the HE-SIG comprises a HE-SIGA and a HE-SIGB, and wherein the HE-SIGB includes a plurality of resource allocations one for each of a plurality of second STAs and the first STA, and wherein the resource allocations are individually encoded or jointly encoded with a separate cyclic redundancy check (CRC) for each resource allocation; decode the HE-SIGA field; and decode the HE-SIGB field based on the HE-SIGA field.

In Example 21, the subject matter of Example 20 can optionally include where the circuitry is further configured to determine which of the plurality of resource allocations is for the first STA based on the CRC being masked with an identification address for the first STA.

In Example 22, the subject matter of Examples 20 and 21 can optionally include where the HE-SIGB is to be encoded with orthogonal frequency division multiple access (OFDMA) symbols.

In Example 23, the subject matter of any of Examples 20-22 can optionally include memory coupled to the circuitry; and one or more antennas coupled to the circuitry.

Example 24 is a non-transitory computer-readable storage medium that stores instructions for execution by one or more processors. The instructions to configure the one or more processors to cause a master station to: generate a high-efficiency signal field (HE-SIG) for a plurality of stations (STAs), where the HE-SIG comprises a HE-SIGA and a HE-SIGB, and where the HE-SIGB includes a plurality of resource allocations one for each of the plurality of STAs, and where the resource allocations are individually encoded or jointly encoded with a separate cyclic redundancy check (CRC) for each resource allocation; and transmit the HE-SIG to each of the plurality of STAs.

In Example 25, the subject matter of Example 24 can optionally include where at least one resource allocation is repeated for at least one of the plurality of resource allocations.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a master station, the apparatus comprising circuitry configured to:
generate a high-efficiency signal field (HE-SIG) for a plurality of stations (STAs), wherein the HE-SIG comprises a HE-SIGA and a HE-SIGB, and wherein the HE-SIGB includes a plurality of resource allocations for the plurality of STAs, and wherein the plurality of resource allocations are one from the following group: individually encoded or jointly encoded with a separate cyclic redundancy check (CRC) for each resource allocation; and
transmit the HE-SIG to the plurality of STAs.

2. The apparatus of the master station of claim 1, wherein resource allocations are for an uplink (UL) multi-user (MU) transmission opportunity (TXOP).

3. The apparatus of the master station of claim 1, wherein the plurality of resource allocations that are individually encoded are not interleaved with one another.

4. The apparatus of the master station of claim 1, wherein each resource allocation includes a field for tail bits.

5. The apparatus of the master station of claim 1, wherein the HE-SIGB further comprises tail bits for the plurality of resource allocations.

6. The apparatus of the master station of claim 1, wherein the HE-SIGA includes one or more from the following group: a modulation and coding scheme (MCS) of the HE-SIGB, repetition information of the HE-SIGB, a symbol length of the HE-SIGB, and guard interval (GI) length of the HE-SIGB.

7. The apparatus of the master station of claim 1, wherein the HE-SIGB is encoded with multiple orthogonal frequency division multiple access (OFDMA) symbols.

8. The apparatus of the master station of claim 1, wherein the plurality of resource allocations are encoded using at least two different modulation and coding schemes.

9. The apparatus of the master station of claim 8, wherein at least one resource allocation is repeated for at least one of the plurality of resource allocations.

10. The apparatus of the master station of claim 1, wherein the CRC is masked with an identification of the corresponding STA.

11. The apparatus of the master station of claim 1, wherein the HE-SIGA further comprises an indication of a pattern of modulation and coding schemes (MCSs) for the plurality of resource allocations.

12. The apparatus of the master station of claim 11, wherein the pattern of MCS is an indication of which resource allocations are to be repeated twice.

13. The apparatus of the master station of claim 1, wherein the circuitry further comprises processing circuitry and transceiver circuitry.

14. The apparatus of the master station of claim 1, further comprising memory coupled to the circuitry; and, one or more antennas coupled to the circuitry.

15. A method on a master station, the method comprising:
generating a high-efficiency signal field (HE-SIG) for a plurality of stations (STAs), wherein the HE-SIG comprises a HE-SIGA and a HE-SIGB, and wherein the HE-SIGB includes a plurality of resource allocations for the plurality of STAs, and wherein the plurality of resource allocations are one from the following group: individually encoded or jointly encoded with a separate cyclic redundancy check (CRC) for each resource allocation; and
transmitting the HE-SIG to the plurality of STAs.

16. The method of claim 15, wherein the HE-SIGB is to be encoded with orthogonal frequency division multiple access (OFDMA) symbols.

17. The method of claim 16, wherein the at least one resource allocation straddles across multiple (OFDMA) symbols.

18. The method of claim 15, wherein the plurality of resource allocations are encoded using at least two modulation and coding schemes.

19. The method of claim 18, wherein at least one resource allocation is repeated for at least one of the plurality of resource allocations.

20. An apparatus of a first station (STA), the apparatus comprising circuitry configured to:
receive a high-efficiency signal field (HE-SIG), wherein the HE-SIG comprises a HE-SIGA and a HE-SIGB, and wherein the HE-SIGB includes a plurality of resource allocations one for each of a plurality of second STAs and the first STA, and wherein the resource allocations are individually encoded or jointly encoded with a separate cyclic redundancy check (CRC) for each resource allocation;
decode the HE-SIGA field; and
decode the HE-SIGB field based on the HE-SIGA field.

21. The apparatus of the first STA of claim 20, wherein the circuitry is further configured to determine which of the plurality of resource allocations is for the first STA based on the CRC being masked with an identification address for the first STA.

22. The apparatus of the first STA of claim 20, wherein the HE-SIGB is to be encoded with orthogonal frequency division multiple access (OFDMA) symbols.

23. The apparatus of the first STA of claim 20, further comprising memory coupled to the circuitry; and one or more antennas coupled to the circuitry.

24. A non-transitory computer-readable storage medium that stores instructions for execution by one or more processors, the instructions to configure the one or more processors to cause a master station to:
generate a high-efficiency signal field (HE-SIG) for a plurality of stations (STAs), wherein the HE-SIG comprises a HE-SIGA and a HE-SIGB, and wherein the HE-SIGB includes a plurality of resource allocations one for each of the plurality of STAs, and wherein the resource allocations are individually encoded or jointly encoded with a separate cyclic redundancy check (CRC) for each resource allocation; and
transmit the HE-SIG to each of the plurality of STAs.

25. The non-transitory computer-readable storage medium of claim 24, wherein at least one resource allocation is repeated for at least one of the plurality of resource allocations.
